(19) United States
(12) Patent Application Publication
(10) Pub. No.: US 2004/0263651 A1
(43) Pub. Date: Dec. 30, 2004

(54) Method and system for printing images captured by a mobile camera telephone

(76) Inventors: Shin Kazunobu, Tokyo (JP); Atsumi Eiji, Kanagawa (JP); Ito Makoto, Todashi (JP); Dutta Amit, Miyamae-ku (JP)

Correspondence Address: Docket Clerk, Scheef & Stone, L.L.P., Suite 1400, 5956 Sherry Lane, Dallas, TX, 75225, US

(21) Appl. No.: 10/611,473

(22) Filed: Jun. 30, 2003

(51) Int. Cl. H04N 5/335

(52) U.S. Cl. 348/272

(57) ABSTRACT

A method and apparatus for of producing a high-quality print from an image captured by a mobile cameras telephone. The captured image is digitized in the form of Bayer data that is then processed to produce image data such as RGB or YUV image data. Raw data is then extracted from the image data, and transported to an external device such as a printer where it is processed to produce image data from which to produce a print of the captured image. The image data may be encoded and decoded prior to the raw data being extracted. The extraction step may be performed in a coprocessor associated with a mobile camera telephone camera module, or in a telephone module of the mobile camera telephone, or in the external device itself.

### FIELD OF THE INVENTION

The present invention relates generally to camera-equipped mobile telephones, and more specifically to a system and method for the direct printing of high-quality images from those images captured by a mobile telephone.

### BACKGROUND OF THE INVENTION

Mobile telephones are becoming ubiquitous. Originally both expensive and cumbersome, they were used only by the wealthy, or by those that both had a definite need for mobile communication capability and could justify the cost of procurement. Significant advances in technology, however, have lead to the development of mobile phones that are both much easier to carry around and far less expensive. As a result, there are now large segments of the population that view mobile telephone ownership almost as a necessity. Many families even provide mobile phones to their children for their personal use.

Mobile telephones are basically portable radios. As such they are generally equipped with a transmitter, a receiver, and some form of antenna. Rather than communicating directly with each other, however, they typically communicate with a nearby base station. The base station, in turn, is connected to a large communication infrastructure that includes numerous switches for routing calls throughout the network, and gateways for communicating with other networks. There are often a great many base stations distributed throughout the network coverage area so that any mobile telephone operating within will always be relatively close to one or more base stations (one to ten miles, for example) through which it may communicate with the network infrastructure.

Protocols have been developed for selecting which base station the mobile telephone will communicate with, and for determining when and how the phone it will be handed over to another base station should it relocate to a different are. The geographic area within which a mobile telephone may communicate with a particular base station is often referred to as a cell, giving rise to the frequently-used terms ‘cellular telephone’ or simply ‘cell phone’. In this disclosure, terms such as ‘cell phone’, ‘mobile phone’, and the common variant ‘mobile station’ will be used interchangeably.

The technological advances referred to above have not been limited to those components directly affecting radio communication. In addition to becoming more portable and compact, modern cell phones are feature rich, meaning that they can perform a great many more functions than simply originating or terminating a telephone call. Some features are relating directly to their function as a telephone. As memory and processing power have improved, for example, large directories of telephone numbers may be stored so that the subscriber does not have to enter in complete numbers for every call. Graphic displays have been added to display a number, or several numbers from the directory, possibly along with various related information such as a name or address.

Some functions involve alternate forms of communication. A cell phone may be able to send and receive short text messages, electronic mail, or even graphic images for presentation on the display. (Depending, of course, on the phone's ability to both receive and process the necessary information.) Other mobile telephones are able to operate in the fashion of walkie-talkies, able to send short voice messages without the need to first set up a dedicated telephone-conversation session. In some mobile phones, pages from the World Wide Web may be accessed.

Other features on modern cell phones bear little direct relation to their telecommunication function. In addition to a telephone directory, for example, an address book and appointment calendar may also be available. There may also be games for the subscriber to play. Note that these functions, while not traditionally associated with telephony, may take advantage of the phone's communication capability. The appointment calendar may be able to synchronize with those of other cell phone users or with personal computers accessible through the Internet. Even games may use the telecommunications network for connecting with other players.

A more recently-developed feature is the integration of a camera into the mobile phone. Mobile camera phones can not only engage in some of the traditional and non-traditional phone functions, but can capture an image and, depending on the capabilities of the mobile phone and of the telecommunication network as a whole, store or display the image, convey it to another mobile phone, or send it to a printer from which a ‘hard copy’ print may be produced. As the present invention is directed to a method and apparatus for producing high-quality prints from a captured mobile camera phone image, the conventional apparatus and process for producing a hard-copy print will now be described.

FIG. 1a is a front perspective view of a typical mobile camera telephone 101. Telephone 101 includes front cover 102 and back cover 103, which together substantially form a housing 104 that encloses the phone's internal circuitry (not shown). As mentioned above this circuitry generally includes a transmitter and a receiver for radio communication using antenna 105. The internal circuitry will also include a controller for controlling the operation of the many of the telephone's components, and at least one information storage device (memory).

Formed in front cover 102 is a plurality of small openings that serve as a speaker port 106 associated with an internal speaker (not shown). An opening formed near the bottom of the telephone functions as a microphone port 107. A larger opening 108 allows the user to view images presented on display 109, which may be, for example, a liquid-crystal display (LCD) protected by a transparent cover (these components are not separately enumerated). A keypad 110 allows the user to make alphanumeric entries and call control keys 111 are used to begin and end a telephone call. Function key 112, as its name implies, performs a variety of functions depending on the specific operation being performed. It may be used, for example, as a ‘shutter button’ that controls when the camera module 120 (shown in FIG. 1b) captures an image. The function at any particular time of function key 112 is often shown on display 109 to confirm for the user what the next activation of the key will do.

Also visible in FIG. 1a is external device interface 115. Interface 115, which may be for example an infrared transmitter and receiver, is used to communicate with external devices such as printer 200 (shown in FIG. 2). Alternately, external device 115 could be a short-range radio transceiver that communicates using, for example, the Bluetooth communication protocol. Or it may simply be a USB port to which a USB communication cable may be attached. Note that interface 115 is typically (though not necessarily) for communicating with nearby external devices and does not handle voice communication or communicate directly with the base stations (described above).

FIG. 1b is a partially exploded reverse perspective view of mobile station 101. A recess 118 is formed in back cover 103 for receiving camera module 120. Camera module includes a housing 121 for enclosing an image-capturing means such as a charge couple device (CCD) (not shown). The CCD is positioned behind lens 122, which focuses incoming light as it enters the camera module. Flash 123, typically a light-emitting diode (LED), provides a short burst of illumination when necessary to successfully capture an image of the subject. Camera module 120 also typically includes a processor (not shown) for (at least initially) processing the captured image. The broken phantom lines in FIG. 1b show the position of camera module 120 in its operational configuration. Note that although camera module 120 is shown as a removable module, it may also be more completely integrated with the rest of mobile camera telephone 101. The modular design simply provides for flexibility in manufacturing, and may present flexibility in use and service maintenance as well.

As should be apparent, appropriate contacts are provided on the camera module and within recess 118 (but are not shown) so that information and electrical power may be conveyed appropriately. Power for the mobile camera telephone 101, including camera module 120, typically comes from a rechargeable battery (also not shown) that is positioned in a battery recess and located interior of battery cover 117. Of course, an external power supply may be used as well.

FIG. 2 is a perspective view of a typical printer 200. Printer 200 includes a housing 201 for enclosing the internal mechanical and electrical components (not shown) used in the printing process. Paper to print on is stored in, and introduced through removable paper tray 202. Printed sheets are, in the illustrated printer, collected in output tray 203. Printer 200 may be an external device with respect to mobile camera telephone 101, and is itself provided with an external device interface 204 for the purpose of effecting communication. Again, this interface may be an infrared transceiver or some other form of interface. Of course, it must be compatible with external device interface 115 of mobile camera telephone 101 if the two are to communicate. The two interfaces, however, need not be identical, and may be (and often are) used for communicating with other external devices as well. Relevant to the present invention however, is the communication between a mobile camera telephone and a printer for the purpose of producing a printed image. (For the sake of clarity, the output of this process will hereinafter be referred to as a ‘print’ or ‘picture’.)

FIG. 3 is a flow diagram illustrating the conventional process 300 for producing a print using a mobile camera telephone and a printer. At START it is presumed the phone and printer are capable of interfacing with each other, and properly configured for respectively capturing and printing the picture. When the user activates the camera by pressing the shutter button (function key) or performing a similar operation, the sensor captures an image (step 305). The captured image represented as Bayer data is then pre-processed by the CCD (step 310) and the resulting signal is then processed by and image processor (step 315), producing image data in either RGB (red, green, blue) or YUV (luminance and chrominance) format. Note that at this point no actual visual image is necessarily created, although in many instances it is desirable; for example to reproduce the captured image on the telephone's display (see FIG. 1a), so that the user may decide whether to send the image for printing. Here it is assumed that the user wishes to do so.

Returning to the method of FIG. 3, the camera coprocessor then encodes the processed image using a JPEG point photographic experts group), or some other acceptable format (step 320). The processor in the mobile camera telephone takes this encoded signal and creates a file, such as an EXIF (exchangeable image file) format file (step 325). (An EXIF file is, generally speaking, a JPEG file that also includes information regarding settings used in capturing the image.) The EXIF file is then transmitted (step 330) to the printer using the phone and printer external device interfaces. The printer receiving the file then decodes it in its own processor (step 335). The output is in the form of RGB or YUV data, which the printer processor then uses for CYMK (cyan, yellow, magenta, black) image creation and color matching (step 340). The CMYK data is then subjected to half-toning (step 345) to produce the pixel data needed to actually print the image. Finally, the printer uses this data to produce the print (step 350).

Although the resulting picture is an easily recognizable reproduction of the image captured by the mobile camera telephone, it is often of less than satisfactory quality especially when compared to the results of more conventional photography. It would therefore be desirable to develop a method, and apparatus for performing it, that produces a high-quality print from the image captured by a mobile camera telephone. The present invention presents just such a solution.

### SUMMARY OF THE INVENTION

In one aspect, the present invention is a method of producing a print from a an image captured by a mobile cameras telephone, including the steps of capturing an image, digitizing the captured image to produce Bayer data, processing the Bayer data to produce image data such as RGB or YUV image data, and extracting raw data from the image data, the raw data for use by an external device in creating external-device image data from which to produce a high-quality print of the captured image. The method may also include the steps of transmitting the raw data and printing the image. The image data may in the external device be subject to further processing such as producing CYMK images, color-matching, and half-toning. The image data produced from the Bayer data may be encoded into a JPEG file and stored prior to being decoded for raw data extraction.

In another aspect, the present invention is a system for producing a print from an image captured by a mobile cameras telephone including an image-capturing device that captures and digitizes an image, an image processor that created image data from the digitized image, an extractor for extracting raw data from the image data, and an external device for processing the extracted data to create external-device image data from which a print may be produced.

In yet another aspect, the present invention is a mobile camera telephone including an interface for receiving digitized Bayer data associated with a captured image from an image capturing device, an image processor for creating image data from the Bayer data, and a data extractor for extracting raw data from the image data. The mobile camera telephone may also include a data storage device for storing data for future processing or transmission.

### BRIEF DESCRIPTION OF THE DRAWINGS

For a more complete understanding of the present invention, and the advantages thereof, reference is made to the following drawings in the detailed description below:

FIG. 1a is a front perspective view of a typical mobile camera telephone.

FIG. 1b is a partially exploded reverse perspective view of the mobile camera telephone of FIG. 1.

FIG. 2 is a perspective view of a typical printer.

FIG. 3 is a flow diagram illustrating the conventional process for producing a print using a mobile camera telephone and a printer.

FIG. 4 is a simplified block diagram illustrating the relationship of selected components of a camera module according to an embodiment of the present invention.

FIG. 5 is a simplified block diagram illustrating the relationship of selected components of a telephone module, operable with the camera module (shown in FIG. 4) according to an embodiment of the present invention.

FIG. 6 is a flow diagram illustrating the process for producing a print using a mobile camera telephone according to an embodiment of the present invention.

FIG. 7 is a flow diagram illustrating in more detail the process of extracting Bayer data for use in accordance with the present invention.

FIG. 8 is a flow diagram illustrating a method for producing a print using a mobile camera telephone and a printer according an embodiment of the present invention.

FIG. 9 is a flow diagram illustrating a method for producing a print using a mobile camera telephone and a printer according an embodiment of the present invention.

### DETAILED DESCRIPTION

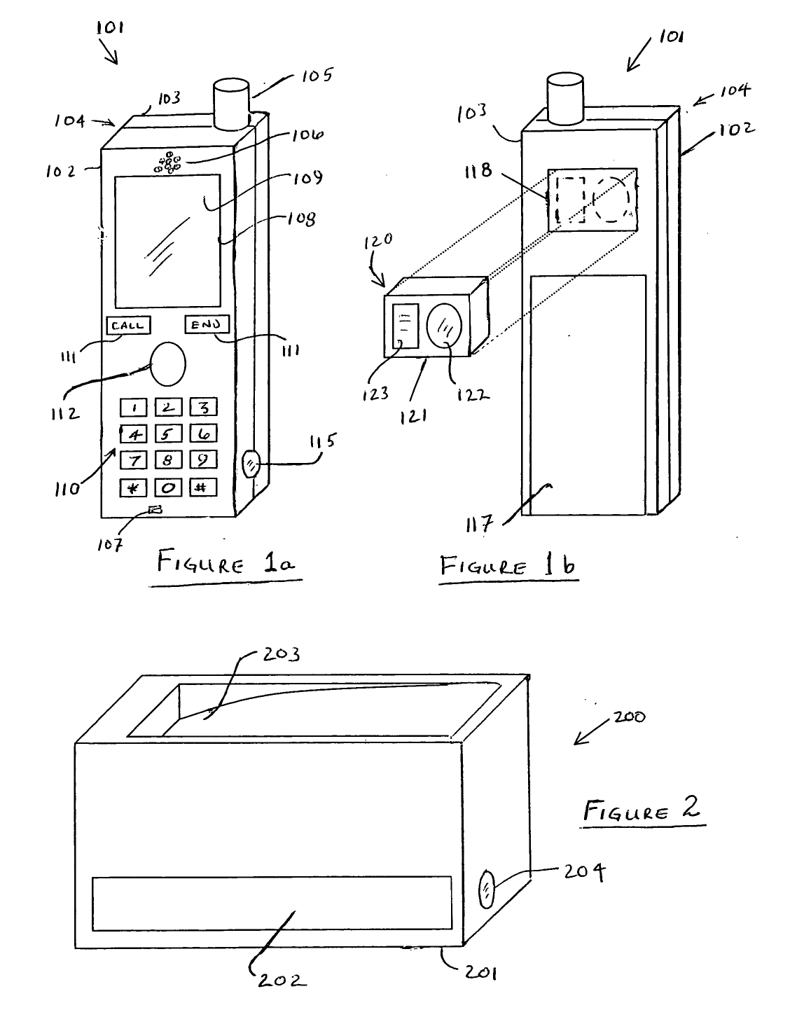

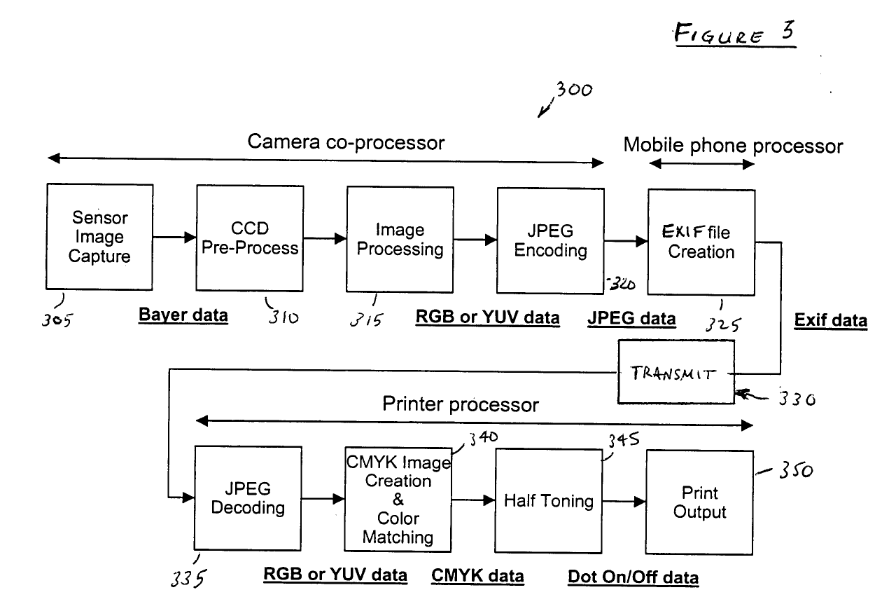

FIGS. 1 through 9, discussed herein, and the various embodiments used to describe the present invention are by way of illustration only, and should not be construed to limit the scope of the invention. Those skilled in the art will understand the principles of the present invention may be implemented in any similar apparatus, in addition to those specifically discussed herein.

The present invention is directed to an improved system and method for producing a print on a printer or similar device from an image captured by a mobile camera telephone. FIG. 4 is a simplified block diagram illustrating the relationship of selected components of a camera module 400 according to an embodiment of the present invention. In the illustrated embodiment, light admitted to the camera module 400 passes through lens 405 creating an image to be captured by a light sensing means 410, in this case a charge-coupled device. (Other light sensors such as CMOS sensors may be used as well.) The captured image is then converted into digital form using an analog front end (AFE) 415 working in cooperation with a timing generator (TG) 420.

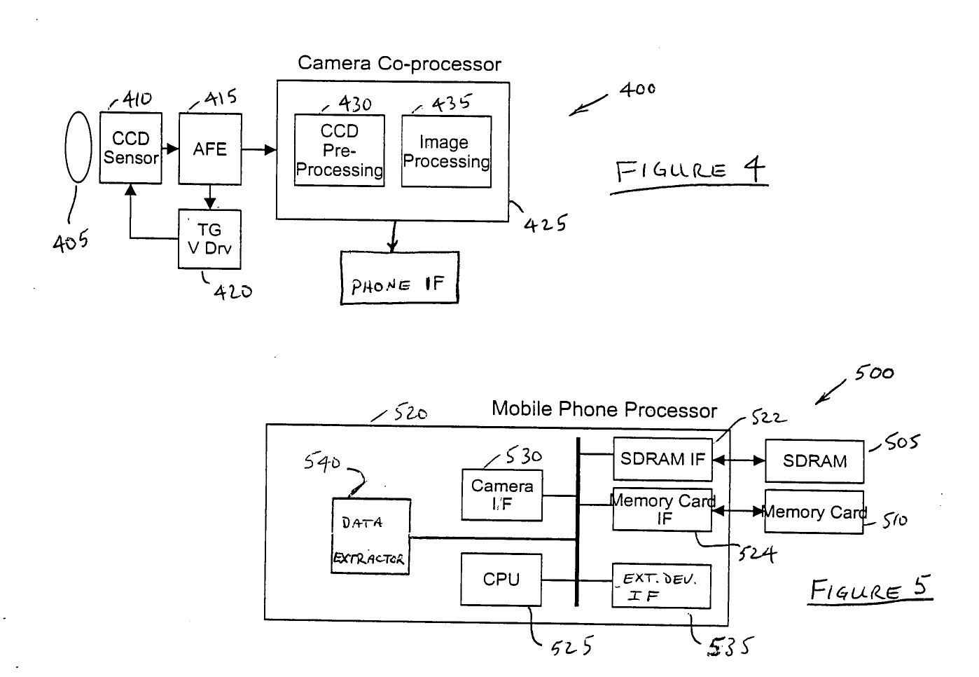

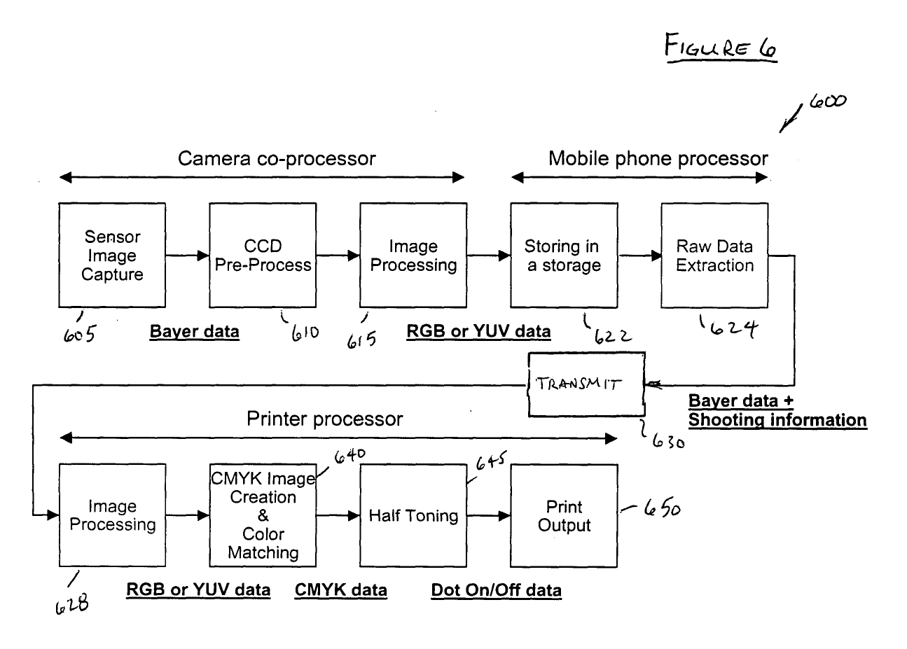

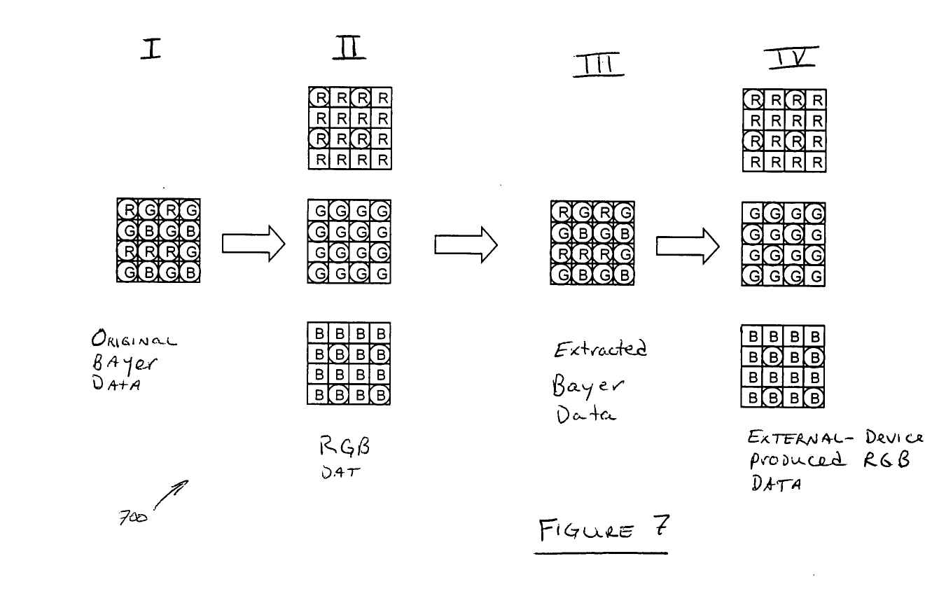

The digitized image is then presented to the camera coprocessor 425. In this embodiment camera coprocessor 425 includes a CCD preprocessor 430 and an image processor 435 and may conventionally process captured images to create a JPEG (or similar) encoded data file. Note that in accordance with the present invention, however, creation of a JPEG file is not necessary. Camera module 400 also includes a telephone module interface 430 for interfacing with the telephone module 500 shown for example in FIG. 5.

Turning now to FIG. 5, which is a simplified block diagram illustrating the relationship of selected components of a telephone module 500, operable with the camera module 400 (shown in FIG. 4) according to an embodiment of the present invention. Illustrated in FIG. 5 is an SDRAM 505 and memory card 510 for short and long term data storage. The processor 520 of telephone module 500 includes an SDRAM interface 522 for transmitting data to and retrieving data from the SDRAM 505. The memory card interface 524 performs an analogous function with respect to the memory card 510. The central processing unit (CPU) 525, of course, handles the core processing functions for both printing operation and other telephone tasks as well. Naturally, however, the mobile telephone processing functions could be distributed among several processing units as well.

Camera module interface 530 provides the conduit for data transfers between telephone module 500 and the corresponding phone interface 430 of camera module 400. In accordance with the present invention, however, telephone module 500 also includes a Bayer data extraction module 540 for extracting Bayer data, that is, for extracting raw data from the RGB or YUV data. This has been found to be of advantage not only because the extracted raw data can be sent more economically, but also because it can be processed in the external device where superior processing power typically resides. Note that while in this embodiment the mobile camera telephone may operate either conventionally, transmitting an EXIF file, or in accordance with the improved process of the present invention, transmitting the extracted Bayer data, this dual capability is not a requirement of the invention itself. Finally, external device interface 435 is provided for transferring information from telephone module 500 to the external device (for example printer 200 shown in FIG. 2). Note that external device interface 525 may also be used when desirable, to transfer data directly from the camera coprocessor 425 to the external device via telephone module interface 430 and camera module interface 530. Alternately, the data sent to the external device may come from a telephone module storage device.

FIG. 6 is a flow diagram illustrating the process 600 for producing a print using a mobile camera telephone according to an embodiment of the present invention. At START it is again presumed the phone and printer are capable of interfacing with each other, and properly configured for respectively capturing and printing the picture. As in the conventional process (see FIG. 3), when the user activates the camera by pressing the shutter button (function key) or performing a similar operation, the sensor captures an image (step 605). The captured image is then pre-processed by the CCD (step 610), for example by performing distortion correction, invalid pixel correction, white balancing, gamma correction, and so forth. The resulting signal is then processed by an image processor (step 615), including for example color filter array (CFA) interpolation.

In accordance with this embodiment of the present invention, the image-processing output (in RGB or YUV format) is provided to the telephone processor 520 (shown in FIG. 5) and stored in a storage device (step 622). The raw data is then extracted (step 624) and transmitted (step 630), along with the setting (shooting) information that would otherwise have been included in the EXIF file (the generation if which is now unnecessary) to an external device such as printer 200 (shown in FIG. 2). There, the raw data is processed (step 628) according the printer's own printing algorithm, outputting a superior image in RGB of YUV data format. The printer processor then uses this RGB or YUV data for CYMK image creation and color matching (step 640). Again, the CMYK data is then subjected to half-toning (step 645) to produce the pixel data needed to actually print the image. Finally, the printer uses this data to produce the print (step 650).

As a result of employing the process of this embodiment, superior print output may be obtained, and at the same time the interface between the mobile camera telephone 101 and the printer 200 is less burdened.

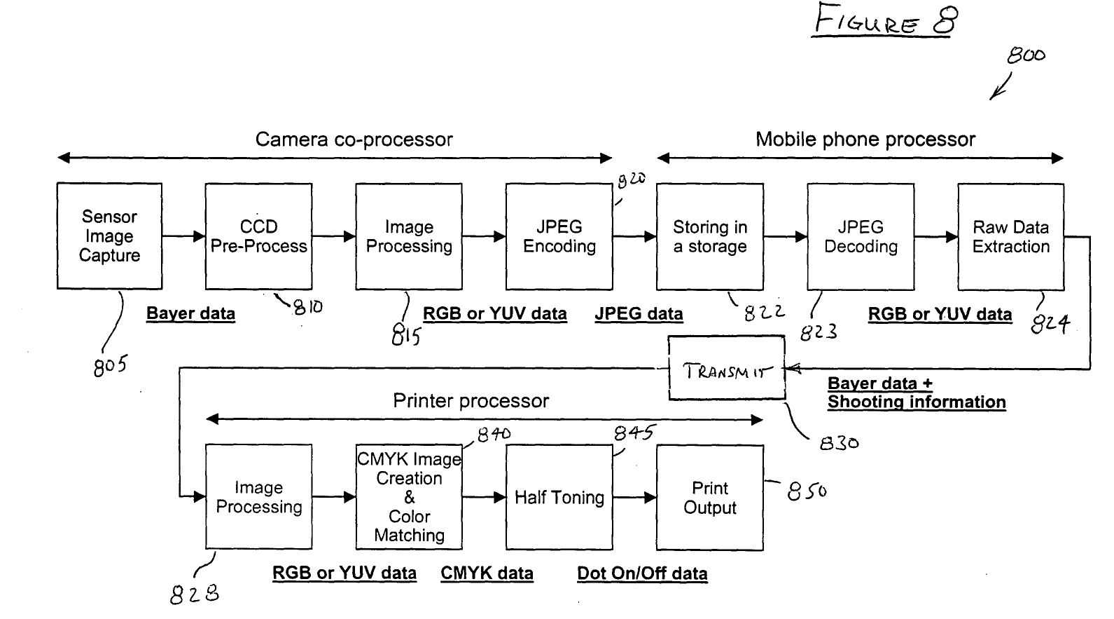

FIG. 7 is a flow diagram illustrating in more detail the process 700 of extracting Bayer data for use in accordance with the present invention. Note that the data output from the light sensor of the mobile telephone camera has an arrangement of a color filter called the Bayer arrangement. The raw data (represented at I) is therefore referred to as “Bayer data”. This Bayer data has one each of red, green, and blue in a unit matrix. RGB data (represented at II) is constructed form the Bayer data. The RGB data has three planes (for red, green, and blue), each having the same resolution as the original Bayer data. In this data, there are places having data that is not real or actual data, but rather includes data that has been interpolated using a data interpolation algorithm. Unfortunately, mobile camera telephones generally do not have the processing power to create good image data in this way.

For this reason, in accordance with the present invention, Bayer image data is extracted to create what will be referred to as extracted raw data or extracted Bayer data, which is represented as III in FIG. 7. Note that the extracted data is not (unless merely by coincidence) identical to the original Bayer data I, some loss is incurred due to the already performed interpolation process. Nevertheless, this loss is in most applications of far less negative significance than is the positive gain in quality experienced when the data is transmitted to a printer where the RGB data can be interpolated using the superior processing and algorithm available there. The external device constructed data is represented at IV in FIG. 7.

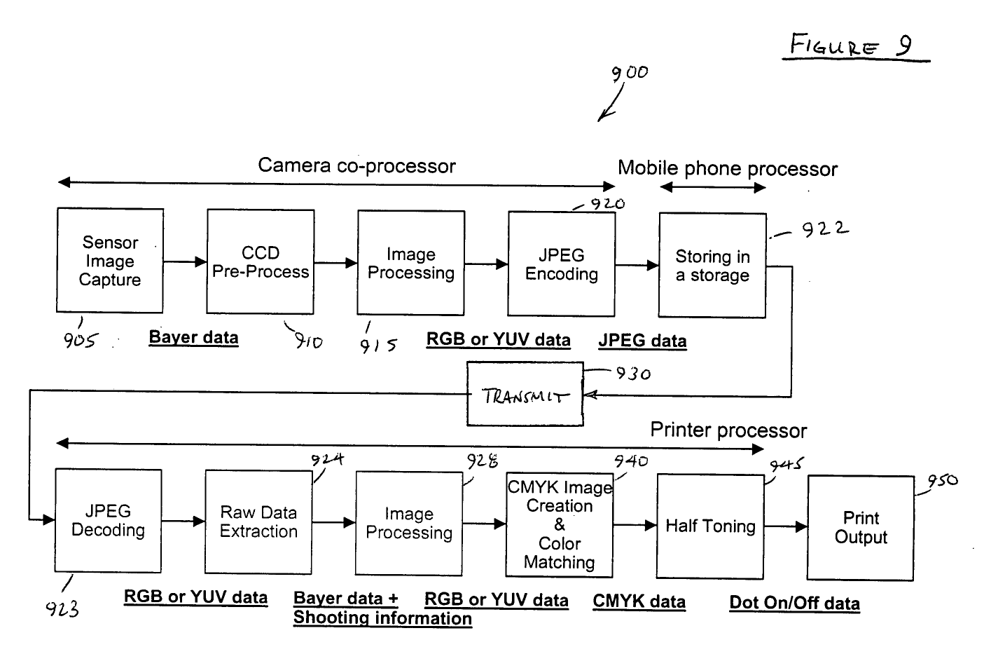

With this detail having been presented, two further embodiments of the present invention will briefly be recited. FIG. 8 is a flow diagram illustrating a method 800 for producing a print using a mobile camera telephone and a printer according an embodiment of the present invention. Because the method 800 contains steps similar to those already having been discussed, only the significant distinctions will be explained here. Note also that while in the various methods illustrated herein analogous reference numbers are used to represent analogous steps, the performance of the similarly numbered steps may not be exactly the same from method to method. Rather, such steps may have minor variations to take into account the order in which they are performed or the location they are performed at. Finally, note that while certain activities are noted as being done in the camera coprocessor or the mobile telephone processor, they may often be performed in either. The separation here reflects typical manufacturing distinctions, but the present invention is equally applicable to mobile devices where certain component are place, or considered to be placed in the other module.

Returning to the embodiment of FIG. 8, in this embodiment the processed image data is subjected to the step of JPEG encoding (step 820) in the camera module 400. Note that this would, if for some reason desirable, permit processing the JPEG data in accordance with the method of FIG. 3. In accordance with this embodiment of the present invention, however, the JPEG encoded data is provided to the mobile telephone processor 520 (shown in FIG. 5) and there stored in a storage device (step 822). From there it is decoded (step 823), and the raw data extracted (step 824) as explained above. The extracted raw data is then transmitted (step 830) to the printer or other external device where it is processed (step 828). The method of FIG. 8 then concludes with CMYK image creation (step 840), half-toning (step 845) and printing (step 850).

FIG. 9 is a flow diagram illustrating a method 900 for producing a print using a mobile camera telephone and a printer according an embodiment of the present invention. In this embodiment, JPEG encoding is again performed at step 920, and the encoded image data is stored in a storage device in the processor 525 of telephone module 500 (step 922). From there, however, it is transmitted (step 930) when appropriate to the printer or other external device. At the external device, the JPEG data is decoded (step 923) and the raw data extracted (step 924). The method of FIG. 9 then concludes with image processing (step 928), CMYK image creation (step 840), half-toning (step 845) and printing (step 850).

The preferred descriptions are of preferred examples for implementing the invention, and the scope of the invention should not necessarily be limited by this description. Rather, the scope of the present invention is defined by the following claims.

What is claimed is:

1. A method of processing an image captured by a mobile camera telephone, said method comprising the steps of:
digitizing the image to obtain Bayer data;
processing the Bayer data to obtain image data; and
extracting raw data from the image data.

2. The method according to claim 1, further comprising the steps of:
transmitting the extracted data to a device external to the mobile camera telephone;
receiving the transmitted data in the external device; and
processing the received data to obtain external device image data.

3. The method of claim 2, further comprising the step of producing a print of the captured image at the external device.

4. The method of claim 2, wherein the external device is a printer.

5. The method of claim 1, wherein the extracting step is performed at an external device.

6. The method of claim 1, wherein the mobile camera telephone includes a camera module and a telephone module.

7. The method of claim 6, wherein the step of processing the Bayer data is performed within the camera module.

8. The method of claim 6, wherein the step of extracting the raw data is performed in the telephone module.

9. The method of claim 8, further comprising the step of storing the image data in the telephone module prior to the extraction step.

10. The method of claim 1, further comprising the steps of;
encoding the image data; and
decoding the encoded image data;
wherein the encoding and decoding steps are performed prior to the extraction step.

11. The method of claim 10, wherein the encoding step is performed according to a JPEG standard.

12. The method of claim 11, further comprising the step of creating an EXIF file including the JPEG encoded image data and shooting data.

13. A system processing an image captured by a mobile camera telephone, said system comprising:
a camera module for capturing and digitizing the image;
an image processor for processing the captured image to produce an image file; and
a data extractor for extracting raw data from the image file.

14. The system of claim 13, further comprising an external device for processing the extracted raw data to produce external-device image data.

15. The system of claim 14, wherein the external device is a printer for producing a print from the external-device image data.

16. The system according to claim 15, wherein the data extractor is located in the printer.

17. The system according to claim 13, further comprising a JPEG encoder for encoding the image data.

18. The system according to claim 13, further comprising a storage device within the mobile camera telephone for storing image data prior to extracting raw data from it.

19. A mobile camera telephone, comprising:
an interface for receiving digitized Bayer data associated with a captured image from an image capturing device;
an image processor for creating image data from the Bayer data; and
a data extractor for extracting raw data from the image data.

20. The mobile camera telephone of claim 19, wherein the image data is RGB data.
